(19) United States
(12) Patent Application Publication
(10) Pub. No.: US 2020/0349444 A1
(43) Pub. Date: Nov. 5, 2020

(54) DATA PROCESSING SYSTEM AND DATA PROCESSING METHOD

(71) Applicant: OLYMPUS CORPORATION, Tokyo (JP)

(72) Inventor: Yoichi YAGUCHI, Tokyo (JP)

(21) Appl. No.: 16/929,746

(22) Filed: Jul. 15, 2020

Related U.S. Application Data
(63) Continuation of application No. PCT/JP2018/001051, filed on Jan. 16, 2018.

(51) Int. Cl. G06N 3/08; G06N 3/04

(52) U.S. Cl. CPC G06N 3/084; G06N 3/0481

(57) ABSTRACT

A data processing system includes a learning unit that optimizes optimization target parameters of a neural network on the basis of a comparison between output data that is output by execution of a process according to a neural network on learning data and ideal output data for the learning data. An activation function f(x) of the neural network is defined, when a first parameter is C and a second parameter being a non-negative value is W, as a function in which an output value for an input value is a value continuous within a range of C±W, the output value for the input value is uniquely determined, and a graph of the function is point-symmetric with respect to a point corresponding to f(x)=C. The learning unit optimizes the optimization target parameters that include the first parameter and the second parameter.

### CROSS-REFERENCE TO RELATED APPLICATIONS

This application is based upon and claims the benefit of priority from International Application No. PCT/JP2018/001051, filed on Jan. 16, 2018, the entire contents of which is incorporated herein by reference.

### BACKGROUND OF THE INVENTION

### 1. Field of the Invention

The present invention relates to a data processing system and a data processing method.

### 2. Description of the Related Art

A neural network is a mathematical model that includes one or more nonlinear units and is a machine learning model that predicts an output corresponding to an input. Many neural networks include one or more intermediate layers (hidden layers) in addition to an input layer and an output layer. The output of each of the intermediate layers is input to the next layer (the intermediate layer or the output layer). Each of layers of the neural network produces an output depending on the input and own parameters.

It is desirable to achieve further stable learning with relatively high accuracy.

### SUMMARY OF THE INVENTION

The present invention has been made in view of such a situation and aims to provide a technique capable of achieving further stable learning with relatively high accuracy.

In order to solve the above problems, a data processing system according to an aspect of the present invention includes a processor that includes hardware, wherein the processor is configured to optimize optimization target parameters of a neural network on the basis of a comparison between output data that is output by execution of a process according to a neural network on learning data and ideal output data for the learning data, an activation function f(x) of the neural network is defined, when a first parameter is C and a second parameter being a non-negative value is W, as a function in which an output value for an input value is a value continuous within a range of C±W, the output value for the input value is uniquely determined, and a graph of the function is point-symmetric with respect to a point corresponding to f(x)=C, and the processor is configured to set an initial value of the first parameter to 0 and optimize the optimization target parameters that include the first parameter and the second parameter.

Another aspect of the present invention is a data processing method. This method includes outputting, by executing a process according to a neural network on learning data to achieve output of output data corresponding to the learning data; and optimizing optimization target parameters of the neural network on the basis of a comparison between the output data corresponding to the learning data and ideal output data for the learning data, wherein an activation function f(x) of the neural network is defined, when a first parameter is C and a second parameter that being a non-negative value is W, as a function in which an output value for an input value is a value continuous within a range of C±W, the output value for the input value is uniquely determined, and a graph of the function is point-symmetric with respect to a point corresponding to f(x)=C, an initial value of the first parameter is set to 0, and the optimization target parameters include the first parameter and the second parameter.

Note that any combination of the above constituent elements, and representations of the present invention converted between a method, a device, a system, a recording medium, a computer program, or the like, are also effective as an aspect of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a block diagram illustrating functions and configurations of a data processing system according to an embodiment;

FIG. 2 is a diagram illustrating a flowchart of a learning process performed by a data processing system; and

FIG. 3 is a diagram illustrating a flowchart of an application process performed by the data processing system.

### DETAILED DESCRIPTION OF THE INVENTION

The invention will now be described by reference to the preferred embodiments. This does not intend to limit the scope of the present invention, but to exemplify the invention.

Hereinafter, the present invention will be described based on preferred embodiments with reference to the drawings.

Before describing the embodiments, the findings as a basis of the present invention will be described. It is known that when the mean value of the input given to a certain layer of a neural network is non-zero in the learning using a gradient, the learning will delay due to the influence of the bias corresponding to the direction of weight updating.

Incidentally, by using the ReLU function as an activation function, it is possible to alleviate a vanishing gradient problem that makes learning of deep neural networks difficult. Deep neural networks that have become capable of learning have achieved high performance in a wide variety of tasks including image classification by improving their expressiveness. Since the ReLU function always has a gradient of 1 for positive inputs, it is possible to alleviate the vanishing gradient problem that occurs when a sigmoid function of which a gradient is always significantly smaller than 1 with respect to an input with a large absolute value is used as an activation function. However, the output of the ReLU function is non-negative and has a mean value that is obviously non-zero. Therefore, the mean value of the input to the next layer might be non-zero, delaying the learning in some cases.

Although Leaky ReLU function, PReLU function, RReLU function, and ELU function with non-zero gradient for negative inputs have been proposed, the mean value of outputs is greater than zero in any case. In addition, the CReLU function and NCReLU function output the channel combination of ReLU (x) and ReLU (−x) in convolutional deep learning, and the BReLU function inverts half of the channels, so as to make the mean value for the entire layer zero. However, there is no solution for the problem that the mean value of each of channels is non-zero. Moreover, these technique cannot be applied to other neural networks without the concept of channels.

Nonlinearity Generator (NG) is defined as f(x)=max(x, a) (a is a parameter), and when a≤min (x), the formula becomes identity mapping, and thus the mean value of the output of each of layers is zero in a neural network initialized to set the mean value of the input of each of layers to zero. Moreover, when initialized as described above, there are experimental results that demonstrate a further progress in the convergence even when the convergence progresses to make the mean value non-zero, and it is known from this that the mean value zero is truly significant at the beginning of learning. Here, when the initial value a0 of a is too small, it takes a lot of time before the convergence starts, and thus, it is also desirable that a0≈min (x0) (x0 is the initial value of x). However, in recent years, the calculation graph structure of the neural network has been complicated, making it difficult to give an appropriate initial value.

Batch Normalization (BN) speeds up learning by normalizing the mean and variance of the whole mini-batch and setting the mean value of the output to zero. However, it has been recently reported that performing a bias shift in a certain layer of the neural network would not ensure the positive homogeneity of the neural network, and there is a local solution with low accuracy.

Therefore, in order to realize more stable learning with relatively high accuracy, that is, in order to solve the learning delay problem, the vanishing gradient problem, the initial value problem, and the low-precision local solution problem, there is a need to use an activation function in which an output mean value is zero in the initial state of the neural network with no bias shift or dependence on the initial value of input and the gradient is sufficiently large (close to 1) in a sufficiently wide range of the value.

Hereinafter, an exemplary case where the data processing device is applied to image processing will be described. It will be understood by those skilled in the art that the data processing device can also be applied to voice recognition processing, natural language processing, and other processes.

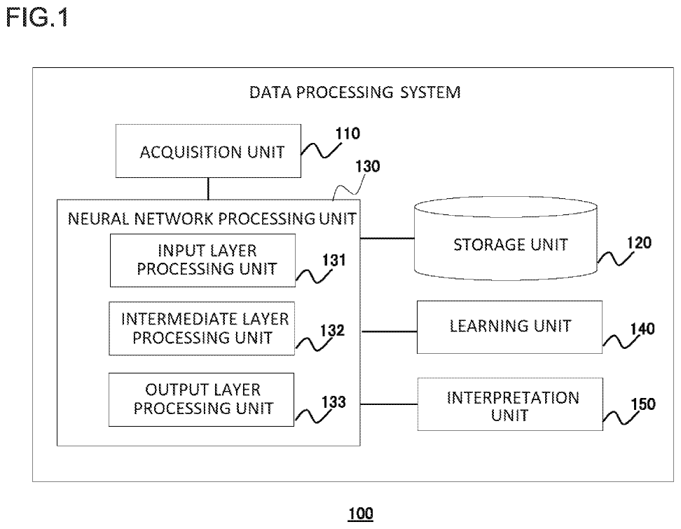

FIG. 1 is a block diagram illustrating functions and configurations of a data processing system 100 according to an embodiment. Each of blocks illustrated here can be implemented by elements or mechanical device such as a central processing unit (CPU) of a computer in terms of hardware, and can be implemented by a computer program in terms of software. However, functional blocks implemented by cooperation of hardware and software are depicted here. Accordingly, implementability of these functional blocks in various forms using the combination of hardware and software would be understandable by those skilled in the art.

The data processing system 100 executes a “learning process” of performing neural network learning based on a training image and a ground truth that is ideal output data for the image and an “application process” of applying a trained neural network on an image and performing image processing such as image classification, object detection, or image segmentation.

In the learning process, the data processing system 100 executes a process according to the neural network on the training image and outputs output data for the training image. Subsequently, the data processing system 100 updates the optimization (learning) target parameters of the neural network (hereinafter referred to as “optimization target parameters”) so that the output data approaches the ground truth. By repeating this, the optimization target parameters are optimized.

In the application process, the data processing system 100 uses the optimization target parameters optimized in the learning process to execute a process according to the neural network on the image, and outputs the output data for the image. The data processing system 100 interprets output data to classify the image, detects an object in the image, or applies image segmentation on the image.

The data processing system 100 includes an acquisition unit 110, a storage unit 120, a neural network processing unit 130, a learning unit 140, and an interpretation unit 150. The functions of the learning process are implemented mainly by the neural network processing unit 130 and the learning unit 140, while the functions of the application process are implemented mainly by the neural network processing unit 130 and the interpretation unit 150.

In the learning process, the acquisition unit 110 acquires at one time a plurality of training images and the ground truth corresponding to each of the plurality of images. Furthermore, the acquisition unit 110 acquires an image as a processing target in the application process. The number of channels is not particularly limited, and the image may be an RGB image or a grayscale image, for example.

The storage unit 120 stores the image acquired by the acquisition unit 110 and also serves as a working area for the neural network processing unit 130, the learning unit 140, and the interpretation unit 150 as well as a storage for parameters of the neural network.

The neural network processing unit 130 executes processes according to the neural network. The neural network processing unit 130 includes: an input layer processing unit 131 that executes a process corresponding to each of components of an input layer of the neural network; an intermediate layer processing unit 132 that executes a process corresponding to each of components of each of layers of one or more intermediate layers (hidden layers): and an output layer processing unit 133 that executes a process corresponding to each of components of an output layer.

The intermediate layer processing unit 132 executes an activation process of applying an activation function to input data from a preceding layer (input layer or preceding intermediate layer) as a process on each of components of each of layers of the intermediate layer. The intermediate layer processing unit 132 may also execute a convolution process, a pooling process, and other processes in addition to the activation process.

The activation function is given by the following Formula (1).

f(x_{c})=max((C_{c}−W_{c}),min((C_{c}+W_{c}),x_{c})) (1)

Here, C_{c} is a parameter indicating a central value of the output value (hereinafter referred to as “central value parameter”), and W_{c} is a parameter being a non-negative value (hereinafter referred to as a “width parameter”). A parameter pair of the central value parameter C_{c} and the width parameter W_{c} is set independently for each of components. For example, a component is a channel of input data, coordinates of input data, or input data itself.

That is, the activation function of the present embodiment is a function in which an output value for an input value is a value continuous within a range of C±W, the output value for the input value is uniquely determined, and a graph of the function is point-symmetric with respect to a point corresponding to f(x)=C. Therefore, in a case where the initial value of the central value parameter C_{c} is set to “0” for example, as described below, the mean value of the output in the initial stage of learning, that is, the mean value of the input to the next layer is obviously zero.

The output layer processing unit 133 performs an operation that combines a softmax function, a sigmoid function, and a cross entropy function, for example.

The learning unit 140 optimizes the optimization target parameters of the neural network. The learning unit 140 calculates an error using an objective function (error function) that compares an output obtained by inputting the training image into the neural network processing unit 130 and a ground truth corresponding to the image. The learning unit 140 calculates the gradient of the parameters by using the gradient back propagation method or the like based on the calculated error as described in non-patent document 1 and then updates the optimization target parameters of the neural network based on the momentum method. In the present embodiment, the optimization target parameters include the central value parameter C_{c} and the width parameter W_{c} in addition to the weights and the bias. For example, the initial value of the central value parameter C_{c} is set to “0” while the initial value of the width parameter W_{c} is set to “1”, for example.

The process performed by the learning unit 140 will be specifically described using an exemplary case of updating the central value parameter C_{c} and the width parameter W_{c}.

Based on the gradient back propagation method, the learning unit 140 calculates the gradient for the central value parameter C_{c} and the gradient for the width parameter W_{c} of the objective function e of the neural network by using the following Formulas (2) and (3), respectively.

$$\begin{matrix}\frac{\partial ɛ}{\partial {C}_{c}} = {\sum }_{{x}_{c}} \frac{\partial ɛ}{\partial f ( {x}_{c} )} \frac{\partial f ( {x}_{c} )}{\partial {C}_{c}} & ( 2 ) \\ \frac{\partial ɛ}{\partial {W}_{c}} = {\sum }_{{x}_{c}} \frac{\partial ɛ}{\partial f ( {x}_{c} )} \frac{\partial f ( {x}_{c} )}{\partial {W}_{c}} & ( 3 )\end{matrix}$$

Here, ∂ε/∂f (x_{c}) is a gradient back-propagated from the succeeding layer.

The learning unit 140 calculates gradients ∂f(x_{c})/∂x_{c}, ∂f(x_{c})/∂C_{c}, and ∂f(x_{c})/∂W_{c} for the input x_{c}, the central value parameter C_{c}, and the width parameter W_{c} in each of components of each of layers of the intermediate layer by using the following Formulas (4), (5) and (6) respectively.

$$\begin{matrix}\frac{\partial f ( {x}_{c} )}{\partial {x}_{c}} = \{ \begin{matrix}1 , & if {C}_{c} - {W}_{c} \leq {x}_{c} \leq {C}_{c} + {W}_{c} \\ 0 , & else\end{matrix} & ( 4 ) \\ \frac{\partial f ( {x}_{c} )}{\partial {C}_{c}} = \{ \begin{matrix}0 , & if {C}_{c} - {W}_{c} \leq {x}_{c} \leq {C}_{c} + {W}_{c} \\ 1 , & else\end{matrix} & ( 5 ) \\ \frac{\partial f ( {x}_{c} )}{\partial {W}_{c}} = \{ \begin{matrix}- 1 & if {x}_{c} < {C}_{c} - {W}_{c} , \\ 1 & if {x}_{c} > {C}_{c} + {W}_{c} , \\ 0 & else\end{matrix} & ( 6 )\end{matrix}$$

The learning unit 140 updates the central value parameter C_{c} and the width parameter W_{c} respectively by the momentum method (Formulas (7) and (8) below) based on the calculated gradient.

$$\begin{matrix}Δ {C}_{c} : = μ Δ {C}_{c} + ϵ \frac{\partial ɛ}{\partial {C}_{c}} & ( 7 ) \\ Δ {W}_{c} := μΔ {W}_{c} + ϵ \frac{\partial ɛ}{\partial {W}_{c}} & ( 8 )\end{matrix}$$

Here,

μ: momentum

η: learning rate

For example, μ=0.9 and η=0.1 will be used as the setting.

In a case where W_{c}<0, the learning unit 140 further updates to satisfy W_{c}=0.

The optimization target parameters will be optimized by repeating the acquisition of the training image by the acquisition unit 110, the process according to the neural network for the training image by the neural network processing unit 130, and the updating of the optimization target parameters by the learning unit 140.

The learning unit 140 also determines whether to end the learning. Examples of the ending conditions for ending the learning include that the learning has been performed a predetermined number of times, an end instruction has been received from the outside, the mean value of the update amount of the optimization target parameters has reached a predetermined value, or that the calculated error falls within a predetermined range. The learning unit 140 ends the learning process when the ending condition is satisfied. In a case where the ending condition is not satisfied, the learning unit 140 returns the process to the neural network processing unit 130.

The interpretation unit 150 interprets the output from the output layer processing unit 133 and performs image classification, object detection, or image segmentation.

Operation of the data processing system 100 according to an embodiment will be described.

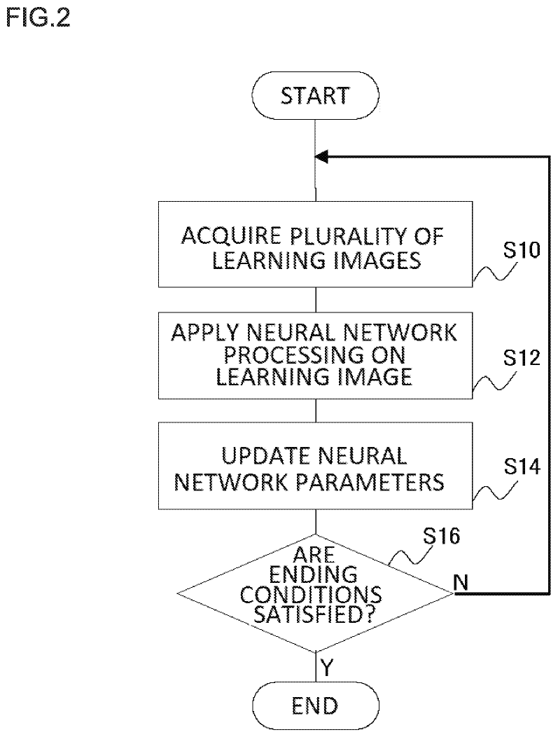

FIG. 2 illustrates a flowchart of the learning process performed by the data processing system 100. The acquisition unit 110 acquires a plurality of training images (S10). The neural network processing unit 130 performs processing according to the neural network on each of the plurality of training images acquired by the acquisition unit 110 and achieves output of output data for each of the images (S12). The learning unit 140 updates the parameters based on the output data and the ground truth for each of the plurality of training images (S14). In updating parameters, the central value parameter C_{c} and the width parameter W_{c} are also updated as optimization target parameters in addition to the weights and the bias. The learning unit 140 determines whether the ending condition is satisfied (S16). In a case where the ending condition is not satisfied (N in S16), the process returns to S10. In a case where the ending condition is satisfied (Y in S16), the process ends.

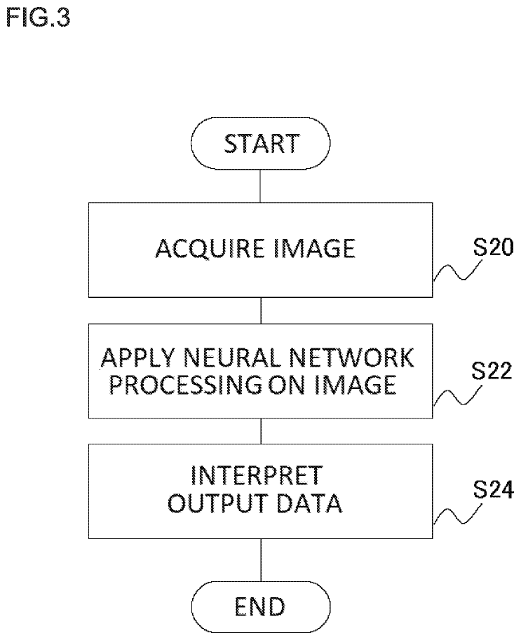

FIG. 3 illustrates a flowchart of the application process performed by the data processing system 100. The acquisition unit 110 acquires the image as an application processing target (S20). The neural network processing unit 130 executes, on the image acquired by the acquisition unit 110, processing according to the neural network in which the optimization target parameters is optimized, that is, the trained neural network, and then outputs output data (S22). The interpretation unit 150 interprets the output data, applies image classification on the target image, detects an object from the target image, or performs image segmentation on the target image (S24).

According to the data processing system 100 of the embodiment described above, the outputs of all the activation functions have an output mean value of zero in the initial state of the neural network with no bias shift or dependence on the initial value of the input and have a gradient of 1 in a certain range of the value. This makes it possible to speed up learning, maintain gradients, reduce initial value dependence, and avoid low-precision local solutions.

The present invention has been described with reference to the embodiments. The present embodiment has been described merely for exemplary purposes. Rather, it can be readily conceived by those skilled in the art that various modification examples may be made by making various combinations of the above-described components or processes, which are also encompassed in the technical scope of the present invention.

### First Modification

The embodiment described above is the case where the activation function is given by Formula (1). However, the present invention is not limited to this. The activation function is only required to be a function in which an output value for an input value is a value continuous within a range of C±W, the output value for the input value is uniquely determined, and a graph of the function is point-symmetric with respect to a point corresponding to f(x)=C. The activation function may be given by the following Formula (9) instead of Formula (1).

$$f ( {x}_{c} ) = {W}_{c} \frac{1 - {e}^{- {x}_{c}}}{1 + {e}^{- {x}_{c}}} + {C}_{c} \qquad ( 9 )$$

In this case, the gradients ∂f(x_{c})/∂x_{c}, ∂f(x_{c})/∂C_{c}, ∂f(x_{c})/∂W_{c} are respectively given by the following Formulas (10), (11), and (12) instead of Formulas (4), (5), (6).

$$\begin{matrix}\frac{\partial f ( {x}_{c} )}{\partial {x}_{c}} = \frac{2 {W}_{c} {e}^{{x}_{c}}}{{( {e}^{{x}_{c}} + 1 )}^{2}} & ( 10 ) \\ \frac{\partial f ( {x}_{c} )}{\partial {C}_{c}} = 1 & ( 11 ) \\ \frac{\partial f ( {x}_{c} )}{\partial {W}_{c}} = \frac{{e}^{{x}_{c}} - 1}{{e}^{{x}_{c}} + 1} & ( 12 )\end{matrix}$$

According to this modification, it is possible to obtain the effects similar to the above embodiment.

### Second Modification

Although not particularly mentioned in the embodiment, when the width parameter W of the activation function of a certain component becomes a predetermined threshold or less and the output value of the activation function becomes relatively small, the output is considered to have no influence on the application process. Accordingly, in a case where the width parameter W of the activation function of a certain component is a predetermined threshold or less, it is not necessary to execute the arithmetic processing that influences only the output by the activation function. That is, it is not necessary to execute the arithmetic processing by the activation function or the arithmetic processing for outputting to the component alone. For example, a component that executes those arithmetic processes alone may be deleted for each of components. This would omit execution of unnecessary arithmetic processing, making it possible to achieve high-speed processing and reduction of memory consumption.

What is claimed is:

1. A data processing system comprising a processor that includes hardware,
wherein the processor is configured to optimize optimization target parameters of a neural network on the basis of comparison between output data that is output by executing a process according to the neural network on learning data and ideal output data for the learning data,
an activation function f(x) of the neural network is defined, when a first parameter is C and a second parameter being a non-negative value is W, as a function in which an output value for an input value is a value continuous within a range of C±W, the output value for the input value is uniquely determined, and a graph of the function is point-symmetric with respect to a point corresponding to f(x)=C, and
the processor is configured to set an initial value of the first parameter to 0 and optimize the optimization target parameters that include the first parameter and the second parameter.

2. The data processing system according to claim 1,
wherein the activation function f(x) is expressed by:
f(x)=max((C−W),min((C+W),x))

3. The data processing system according to claim 1,
wherein the activation function f(x) is expressed by:
$$f ( x ) = W \frac{1 - {e}^{- x}}{1 + {e}^{- x}} + C .$$

4. The data processing system according to claim 1,
wherein the neural network is a convolutional neural network and has the first parameter and the second parameter that are independent for each of components.

5. The data processing system according to claim 4,
wherein the component is a channel.

6. The data processing system according to claim 1,
wherein the processor is configured to not execute a calculation process that influences only an output by the activation function in a case where the second parameter is a predetermined threshold or below.

7. A data processing method comprising:
outputting, by executing a process according to a neural network on learning data, output data corresponding to the learning data; and
optimizing optimization target parameters of the neural network on the basis of comparison between the output data corresponding to the learning data and ideal output data for the learning data,
wherein an activation function f(x) of the neural network is defined, when a first parameter is C and a second parameter being a non-negative value is W, as a function in which an output value for an input value is a value continuous within a range of C±W, the output value for the input value is uniquely determined, and a graph of the function is point-symmetric with respect to a point corresponding to f(x)=C,
an initial value of the first parameter is set to 0, and
the optimization target parameters include the first parameter and the second parameter.

8. A non-transitory computer readable medium encoded with a program executable by a compute, the program comprising:
optimizing optimization target parameters of a neural network on the basis of comparison between output data that is output by executing a process according to the neural network on learning data and ideal output data for the learning data,
wherein an activation function f(x) of the neural network is defined, when a first parameter is C and a second parameter being a non-negative value is W, as a function in which an output value for an input value is a value continuous within a range of C±W, the output value for the input value is uniquely determined, and a graph of the function is point-symmetric with respect to a point corresponding to f(x)=C, and
the optimizing the optimization target parameters sets an initial value of the first parameter to 0 and optimizes the optimization target parameters that include the first parameter and the second parameter.
